(19) United States
(12) Patent Application Publication
(10) Pub. No.: US 2016/0343079 A1
(43) Pub. Date: Nov. 24, 2016

(54) SYSTEM AND METHODS FOR COMPLETING A PORTFOLIO ACCORDING TO A FACTOR BLEND ANALYSIS

(71) Applicants: Vijay Vaidyanathan, Los Altos, CA (US); Himanshu Monty Joshi, Los Altos, CA (US); Daniel Mantilla Garcia, Los Altos, CA (US); Andrew Ang, Los Altos, CA (US); Helmut Hissen, Los Altos, CA (US)

(72) Inventors: Vijay Vaidyanathan, Los Altos, CA (US); Himanshu Monty Joshi, Los Altos, CA (US); Daniel Mantilla Garcia, Los Altos, CA (US); Andrew Ang, Los Altos, CA (US); Helmut Hissen, Los Altos, CA (US)

(73) Assignee: OPTIMAL ASSETT MANAGEGMENT, Los Altos, CA (US)

(21) Appl. No.: 14/716,843

(22) Filed: May 19, 2015

(51) Int. Cl. G06Q 40/06

(52) U.S. Cl. CPC G06Q 40/06

(57) ABSTRACT

The system uploads an existing portfolio and provides a synthesize process to determine how the existing portfolio fares against the factors disclosed above. The existing portfolio is scored and ranked, and factor results are provided. The user then inputs a target factor portfolio using the factors disclosed above. The existing portfolio is then compared against the target portfolio. The result is a completion portfolio to complement the existing portfolio and derive an overall exposure in line with investor objectives.

### FIELD OF THE INVENTION

The invention relates to evaluating a portfolio according to a factor exposure analysis and then selecting a factor blend to achieve an overall factor exposure result.

### DISCUSSION OF THE RELATED ART

Many investors pick funds or stocks based on different criteria. Recommendations, trends, levels of risks, and the like are weighed against the investors' needs or desires. This approach, however, may not address the real opportunity for an investor to understanding the true sources of his returns while meeting objectives.

“Factor” premia have been identified in academic literature as a way of understanding the underlying sources of returns and risks of stocks.

### SUMMARY OF THE INVENTION

According to the disclosed embodiments, a user may select a target factor blend by evaluating the current factor exposure of an existing portfolio, such as a mutual fund or a separately managed account. This compare function allows the disclosed embodiments to perform a returns-based factor analysis. A returns-based factor analysis involves using the historical return series of an uploaded portfolio or fund to reverse engineer the respective factor exposures of a given portfolio. Preferably, a Sharpe's returns-based style analysis may be used.

This analysis may include the following steps. A user uploads the historical return series of a current fund or portfolio. The historical return series are generally readily available for most funds or portfolios. The disclosed embodiments perform a factor analysis and display the result on display device using a graphical interface. The analysis synthesizes, or replicates, the uploaded portfolio in terms of factor exposures.

Using a graphical user interface specific to the disclosed embodiments, the user can select a factor blend that replicates the result of the factor analysis, and then compare the returns of the synthesized portfolio with the original portfolio using a blend function.

Based in part on analytics done by the user within the software, the user can decide on the overall factor blend he desires that complements the existing portfolio.

Finally, the user can build a portfolio based on desired overall factor exposures that complement the existing fund or funds, to achieve the desired overall factor exposure result. This feature may be called building a completion portfolio. In a long-short context, the disclosed approach offers the benefit of netting security positions across portfolios, in a manner that is not available to those who pursue a factor-based strategy using exchange traded funds (ETFs). This results in greater transactional efficiencies in the aggregate holdings profile, which improves both cost and capital allocation efficiencies.

Thus, a method for building a completion portfolio for an existing portfolio is disclosed. The method includes estimating a factor allocation for the existing portfolio. The factor allocation includes a set of factors. The method also includes determining a target factor portfolio based on a selected factor blend of the set of factors. The method also includes comparing the target portfolio to the factor allocation of the existing portfolio to determine a difference between the factor allocation and the selected factor blend. The method also includes building a completion portfolio according to the difference.

Another method for building a completion portfolio also is disclosed. The method includes uploading an existing portfolio. The method also includes analyzing a return series for the existing portfolio to estimate an allocation of factor blends within the existing portfolio. The method also includes selecting a target factor blend for a target portfolio. The method also includes comparing the target factor blend to the estimated allocation of factor blends. The method also includes determining a completion portfolio based on the comparison.

A physical and tangible computer readable medium for storing non-transitory computer readable instructions also is disclosed. The computer readable instructions perform a method for building a completion portfolio for an existing portfolio when executed by one or more processing devices. The method includes estimating a factor allocation for the existing portfolio. The factor allocation includes a set of factors. The method also includes determining a target factor portfolio based on a selected factor blend of the set of factors. The method also includes comparing the target portfolio to the factor allocation of the existing portfolio to determine a difference between the factor allocation and the selected factor blend. The method also includes building a completion portfolio according to the difference.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed by the claims and their equivalents.

FIG. 1 illustrates a system for completion portfolio analysis using factors according to the disclosed embodiments.

FIG. 2 illustrates a device for use in the system of FIG. 1 according to the disclosed embodiments.

FIG. 3A illustrates a flowchart for determining a completion portfolio according to the disclosed embodiments.

FIG. 3B illustrates a flowchart for synthesizing a current factor exposure and a completing a portfolio according to the disclosed embodiments.

FIG. 4 illustrates a flowchart for the synthesize process according to the disclosed embodiments.

### DETAILED DESCRIPTION OF THE PREFERRED EMBODIMENTS

Aspects of the invention are disclosed in the accompanying description. Alternate embodiments of the present invention and their equivalents are devised without parting from the spirit or scope of the present invention. It should be noted that like elements disclosed below are indicated by like reference numbers in the drawings. While the embodiments discussed below describe completion portfolio factor analysis, methods of building a portfolio, and equity risk factors, these approaches are not so limited and equally applicable to other asset classes (such as fixed income or commodities) and other investment factors (such as credit spreads or term spreads).

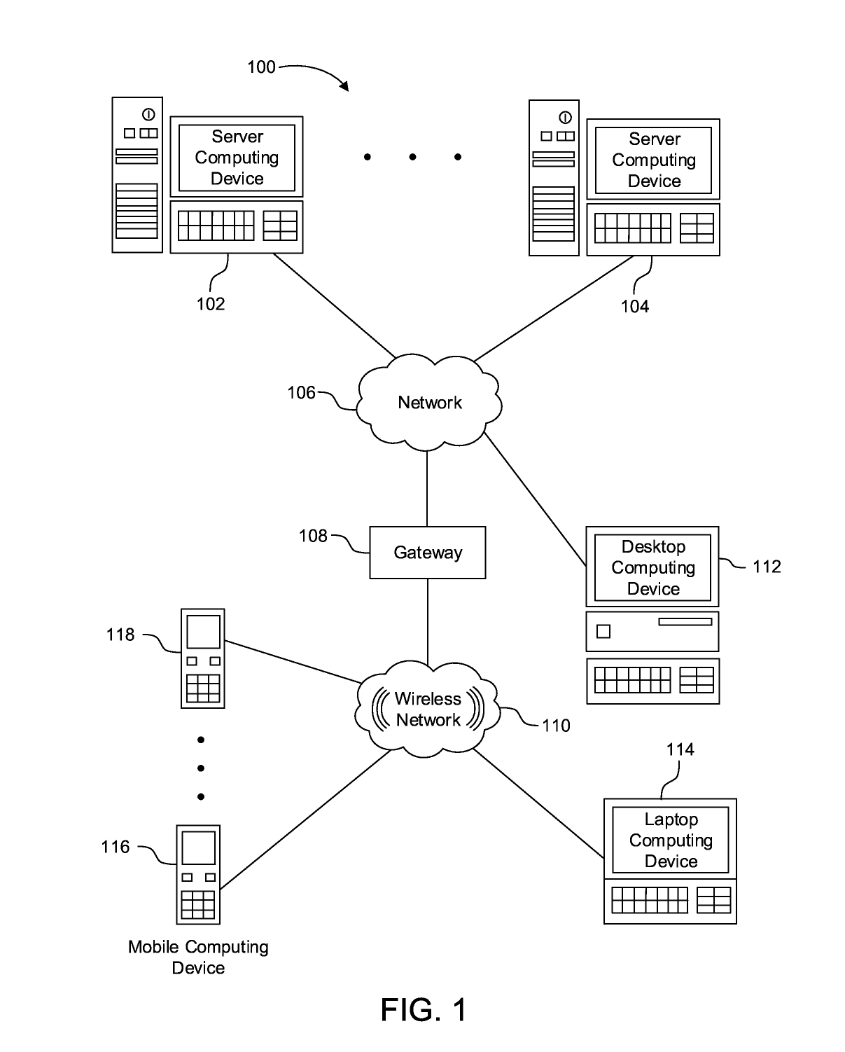

FIG. 1 depicts a system 100 for performing a completion portfolio factor analysis according to the disclosed embodiments. Other components may be included in system 100 not shown in FIG. 1. The disclosure of FIG. 1 is shown for clarity and may include any of these additional components to perform the functionality disclosed herein.

System 100 may include local area networks (LAN) and wide area network (WAN) shown as network 106 and wireless network 110. Gateway 108 is configured to connect remote or different types of networks together, as well as client computing devices 112-118 and server computing devices 102-104.

Client computing devices 112-118 may include any device capable of receiving and sending data over a network, such as wireless network 110. Devices 112-118 may include portable devices such as cellular telephones, smart phones, radio frequency-enabled devices, personal digital assistants, handheld computers, tablets, laptop computers, wearable computers and the like. Devices 112-118 also may include any computing device that connects to a network using a wired communications medium such as personal computers, multiprocessor systems, microprocessor-based or programmable consumer electronics, network personal computers and the like.

Client computing devices 112-118 also may be web-enabled client devices that include a browser application configured to receive and to send web pages, web-based messages and the like. The browser application may be configured to receive and display graphic, text, multimedia, or the like, employing virtually any web based language, including a wireless application protocol messages (WAP), or the like. In one embodiment, the browser application may be enabled to employ one or more of Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client computing devices 112-118 also may include at least one other client application that is configured to receive content from another computing device, including, without limit, server computing devices 102-104. The client application may include a capability to provide and receive textual content, multimedia information, or the like. The client application may further provide information that identifies itself, including a type, capability, name, or the like. In one embodiment, client devices 112-118 may uniquely identify themselves through any of a variety of mechanisms, including a phone number, mobile identification number (MIN), an electronic serial number (ESN), mobile device identifier, network address, such as IP (Internet Protocol) address, media access control (MAC) layer identifier, or other identifier. The identifier may be provided in a message, or the like, sent to another computing device.

Client computing devices 112-118 may also be configured to communicate a message, such as through email, short message service (SMS), multimedia message service (MMS), instant messaging (IM), internet relay chat (IRC), Mardam-Bey's IRC (mIRC), Jabber, or the like, to another computing device.

Client devices 112-118 may further be configured to include a client application that enables the user to log into a user account that may be managed by another computing device. Such a user account, for example, may be configured to enable the user to receive emails, send/receive IM messages, SMS messages, access selected web pages, download scripts, applications, or a variety of other content, or perform a variety of other actions over a network. Management of messages or otherwise accessing and/or downloading content, may also be performed without logging into the user account. Thus, a user of client devices 112-118 may employ any of a variety of client applications to access content, read web pages, receive/send messages, or the like.

In one embodiment, for example, the user may employ a browser or other client application to access a web page hosted by a Web server implemented as server computing device 102. Messages received by client computing devices 112-118 may be saved in non-volatile memory, such as flash and/or PCM, across communication sessions and/or between power cycles of client computing devices 112-118.

Wireless network 110 may be configured to couple client devices 114-118 to network 106. Wireless network 110 may include any of a variety of wireless sub-networks that may further overlay stand-alone ad-hoc networks, and the like, to provide an infrastructure-oriented connection for client devices 114-118. Such sub-networks may include mesh networks, Wireless LAN (WLAN) networks, cellular networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G), 5th (5G) and the like generation radio access for cellular systems, WLAN, Wireless Router (WR) mesh, and the like. Access technologies such as 2G, 3G, 4G, 5G and future access networks may enable wide area coverage for mobile devices, such as client devices 114-118 with various degrees of mobility. For example, wireless network 110 may enable a radio connection through a radio network access such as global system for mobile communication (GSM), general packet radio services (GPRS), enhanced data GSM environment (EDGE), WEDGE, Bluetooth, high speed downlink packet access (HSDPA), universal mobile telecommunications system (UMTS), Wi-Fi, Zigbee, wideband code division multiple access (WCDMA), and the like. In essence, wireless network 110 may include virtually any wireless communication mechanism by which information may travel between client devices 102-104 and another computing device, network, and the like.

Network 106 is configured to couple one or more servers depicted in FIG. 1 as server computing devices 102-104 and their respective components with other computing devices, such as client device 112, and through wireless network 110 to client devices 114-118. Network 106 is enabled to employ any form of computer readable media for communicating information from one electronic device to another. Network 106 also may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Network 106 may include any communication method by which information may travel between computing devices. Additionally, communication media typically may enable transmission of computer-readable instructions, data structures, program modules, or other types of content, virtually without limit. By way of example, communication media includes wired media such as twisted pair, coaxial cable, fiber optics, wave guides, and other wired media and wireless media such as acoustic, RF, infrared, and other wireless media.

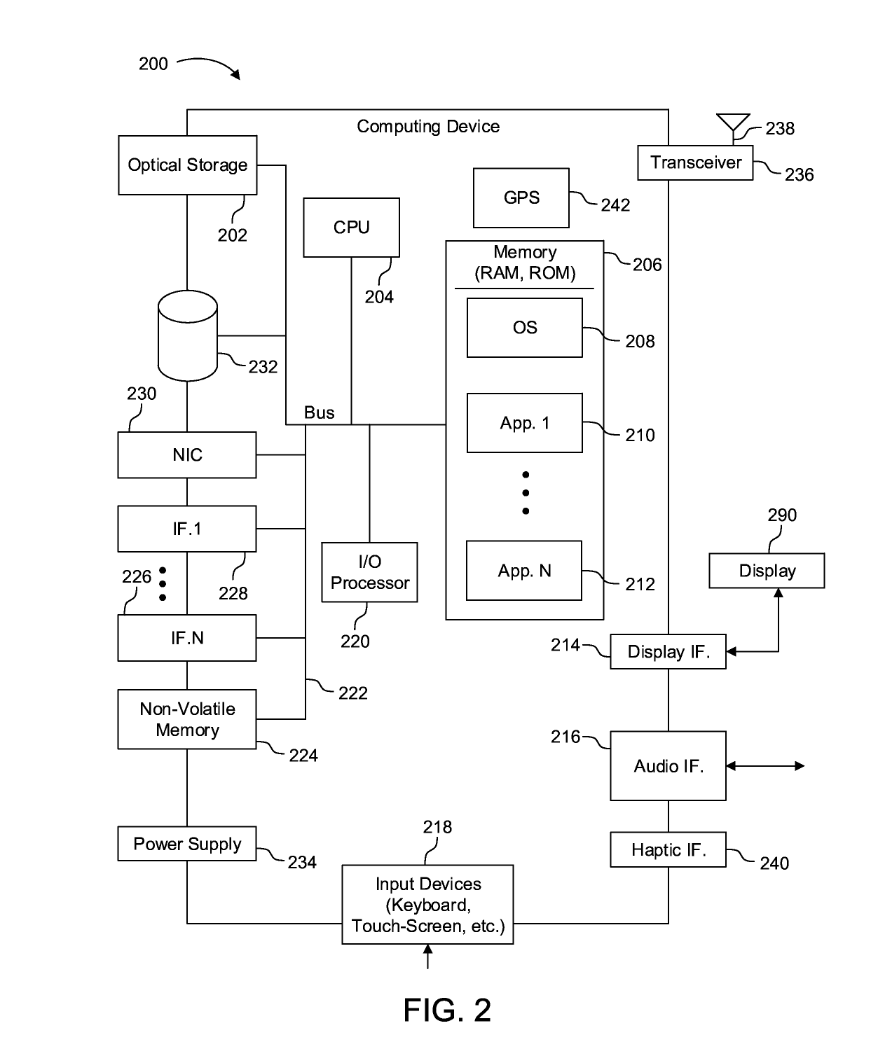

FIG. 2 depicts a computing device 200 configured to execute the functionality disclosed in greater detail below. Computing device 200 may communicate with other devices over system 100 to perform the functions needed for the completion portfolio analysis. Computing device 200 may be representative of any of the computing devices shown in FIG. 1.

Computing device 200 includes optical storage 202, central processing unit (CPU) 204, memory module 206, display interface 214, audio interface 216, input devices 218, input/output (I/O) processor 220, bus 222, non-volatile memory 224, various other interfaces 226-228, network interface card (NIC) 320, hard disk 232, power supply 234, transceiver 236, antenna 238, haptic interface 240, and global positioning system (GPS) unit 242. Memory module 206 may include software such as operating system (OS) 208, and a variety of software application programs and/or software modules/components 210-212. Such software modules and components may be stand-alone application software or be components, such as DLL (Dynamic Link Library) of larger application software.

Computing device 200 may also include other components not shown in FIG. 2. For example, computing device 200 may further include an illuminator (for example, a light), graphic interface, and portable storage media such as USB drives. Computing device 200 may also include other processing units, such as a math co-processor, graphics processor/accelerator, and a Digital Signal Processor (DSP).

Optical storage device 202 may include optical drives for using optical media, such as CD (Compact Disc), DVD (Digital Video Disc), and the like. Optical storage devices 202 may provide inexpensive ways for storing information for archival and/or distribution purposes.

Central processing unit (CPU) 204 may be the main processor for software program execution in computing device 200. CPU 204 may represent one or more processing units that obtain software instructions from memory module 206 and execute such instructions to carry out computations and/or transfer data between various sources and destinations of data, such as hard disk 232, I/O processor 220, display interface 214, input devices 218, non-volatile memory 224, and the like.

Memory module 206 may include RAM (Random Access Memory), ROM (Read Only Memory), and other storage means, mapped to one addressable memory space. Memory module 206 illustrates one of many types of computer storage media for storage of information such as computer readable instructions, data structures, program modules or other data. Memory module 206 may store a basic input/output system (BIOS) for controlling low-level operation of computing device 200. Memory module 206 may also store OS 208 for controlling the general operation of computing device 200. It will be appreciated that OS 208 may include a general-purpose operating system such as a version of UNIX, or a specialized client-side and/or mobile communication operating system. OS 208 may, in turn, include or interface with a Java virtual machine (JVM) module that enables control of hardware components and/or operating system operations via Java application programs.

Memory module 206 may further include one or more distinct areas (by address space and/or other means), which can be utilized by computing device 200 to store, among other things, applications and/or other data. For example, one area of memory module 206 may be set aside and employed to store information that describes various capabilities of computing device 200, a device identifier, and the like. Such identification information may then be provided to another device based on any of a variety of events, including being sent as part of a header during a communication, sent upon request, or the like.

One common software application is a browser program that is generally used to send/receive information to/from a web server. In one embodiment, the browser application is enabled to employ handheld device markup language (HDML), wireless markup language (WML), WMLScript, JavaScript, standard generalized markup language (SMGL), hypertext markup language (HTML), eXtensible markup language (XML), and the like, to display and send a message. Any of a variety of other web based languages may also be employed. In one embodiment, using the browser application, a user may view an article or other content on a web page with one or more highlighted portions as target objects.

Display interface 214 may be coupled with a display unit 290, such as liquid crystal display (LCD), gas plasma, light emitting diode (LED), or any other type of display unit that may be used with computing device 200. Display unit 290 coupled with display interface 214 may also include a touch sensitive screen arranged to receive input from an object such as a stylus or a digit from a human hand. Display interface 214 may further include interface for other visual status indicators, such light emitting diodes (LED), light arrays, and the like. Display interface 214 may include both hardware and software components. For example, display interface 214 may include a graphic accelerator for rendering graphic-intensive outputs on the display unit. In one embodiment, display interface 214 may include software and/or firmware components that work in conjunction with CPU 204 to render graphic output on the display unit.

Audio interface 216 is arranged to produce and receive audio signals such as the sound of a human voice. For example, audio interface 216 may be coupled to a speaker and microphone to enable communication with a human operator, such as spoken commands, and/or generate an audio acknowledgement for some action.

Input devices 218 may include a variety of device types arranged to receive input from a user, such as a keyboard, a keypad, a mouse, a touchpad, a touch-screen (described with respect to display interface 214), a multi-touch screen, a microphone for spoken command input (describe with respect to audio interface 216), and the like.

I/O processor 220 is generally employed to handle transactions and communications with peripheral devices such as mass storage, network, input devices, display, and the like, which couple computing device 200 with the external world. In small, low power computing devices, such as some mobile devices, functions of the I/O processor 220 may be integrated with CPU 204 to reduce hardware cost and complexity. In one embodiment, I/O processor 220 may the primary software interface with all other device and/or hardware interfaces, such as optical storage 202, hard disk 232, interfaces 226-228, display interface 214, audio interface 216, and input devices 218.

An electrical bus 222 internal to computing device 200 may be used to couple various other hardware components, such as CPU 204, memory module 206, I/O processor 220, and the like, to each other for transferring data, instructions, status, and other similar information.

Non-volatile memory 224 may include memory built into computing device 200, or portable storage medium, such as USB drives that may include PCM arrays, flash memory including NOR and NAND flash, pluggable hard drive, and the like. In one embodiment, portable storage medium may behave similarly to a disk drive. In another embodiment, portable storage medium may present an interface different than a disk drive, for example, a read-only interface used for loading/supplying data and/or software.

Various other interfaces 226-228 may include other electrical and/or optical interfaces for connecting to various hardware peripheral devices and networks, such as IEEE 1394 also known as FireWire, Universal Serial Bus (USB), Small Computer Serial Interface (SCSI), parallel printer interface, Universal Synchronous Asynchronous Receiver Transmitter (USART), Video Graphics Array (VGA), Super VGA (SVGA), and the like.

Network interface card (NIC) 230 may include circuitry for coupling computing device 200 to one or more networks, and is generally constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth, Wi-Fi, Zigbee, UMTS, HSDPA, WCDMA, WEDGE, or any of a variety of other wired and/or wireless communication protocols.

Hard disk 232 is generally used as a mass storage device for computing device 200. In one embodiment, hard disk 232 may be a Ferro-magnetic stack of one or more disks forming a disk drive embedded in or coupled to computing device 200. Alternatively, hard drive 232 may be implemented as a solid-state device configured to behave as a disk drive, such as a flash-based hard drive. In yet another embodiment, hard drive 232 may be a remote storage accessible over network interface 230 or another interface 226, but acting as a local hard drive.

Power supply 234 provides power to computing device 200. A rechargeable or non-rechargeable battery may be used to provide power. The power may also be provided by an external power source, such as an AC adapter or a powered docking cradle that supplements and/or recharges a battery.

Transceiver 236 generally represents transmitter/receiver circuits for wired and/or wireless transmission and receipt of electronic data. Transceiver 236 may be a stand-alone module or be integrated with other modules, such as NIC 230. Transceiver 236 may be coupled with one or more antennas for wireless transmission of information.

Antenna 238 is generally used for wireless transmission of information, for example, in conjunction with transceiver 236, NIC 230, and/or GPS 242. Antenna 238 may represent one or more different antennas that may be coupled with different devices and tuned to different carrier frequencies configured to communicate using corresponding protocols and/or networks. Antenna 238 may be of various types, such as omni-directional, dipole, slot, helical, and the like.

Haptic interface 240 is configured to provide tactile feedback to a user of computing device 200. For example, the haptic interface may be employed to vibrate computing device 200, or an input device coupled to computing device 200. For example, when a message is received by device 200 or another event occurs, the device may vibrate to alert the user.

Global positioning system (GPS) unit 242 can determine the physical coordinates of computing device 200 on the surface of the Earth, which typically outputs a location as latitude and longitude values. GPS unit 242 can also employ other geo-positioning mechanisms, including, but not limited to, triangulation, assisted GPS (AGPS), E-OTD, CI, SAI, ETA, BSS or the like, to further determine the physical location of computing device 200 on the surface of the Earth. It is understood that under different conditions, GPS unit 242 can determine a physical location within millimeters for computing device 200. In other cases, the determined physical location may be less precise, such as within a meter or significantly greater distances. In one embodiment, however, a mobile device represented by computing device 200 may, through other components, provide other information that may be employed to determine a physical location of the device, including for example, a MAC address.

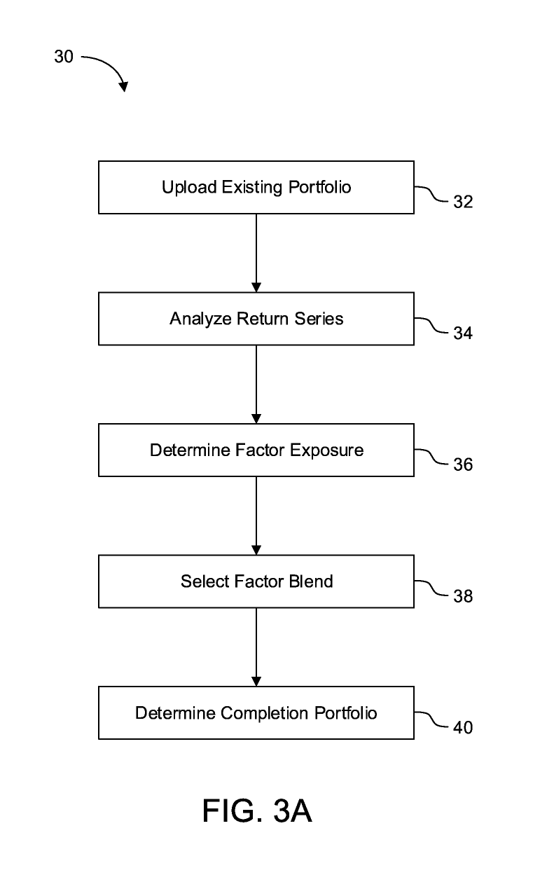

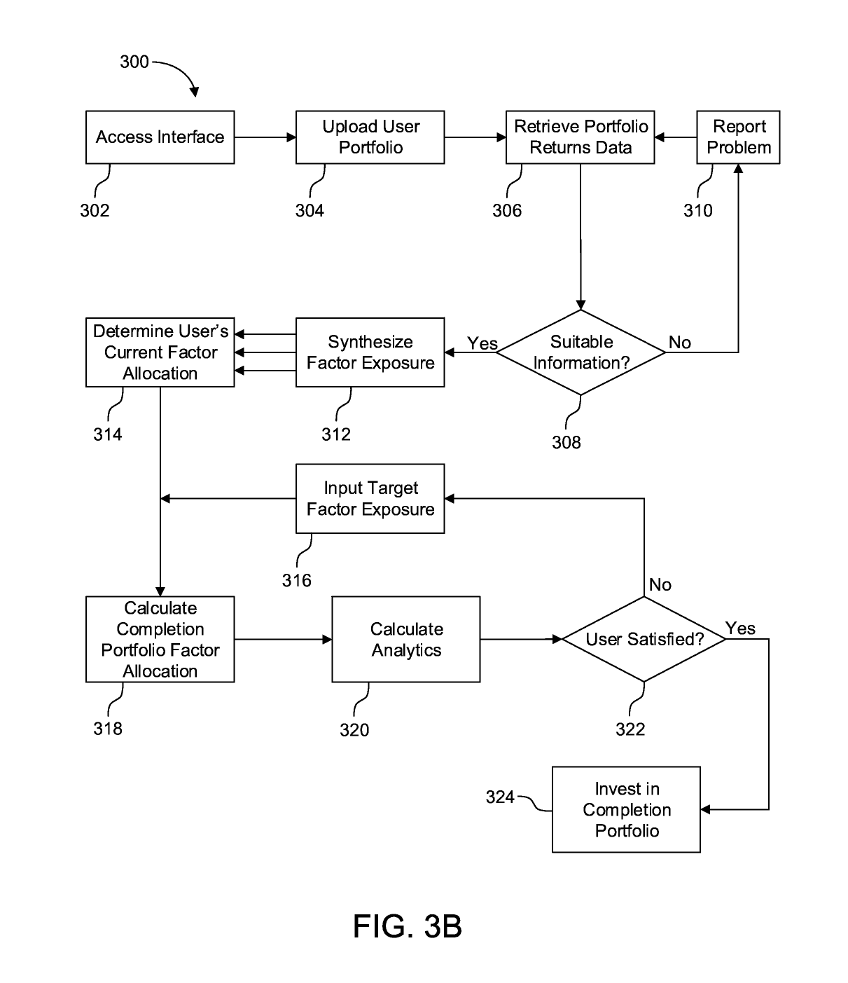

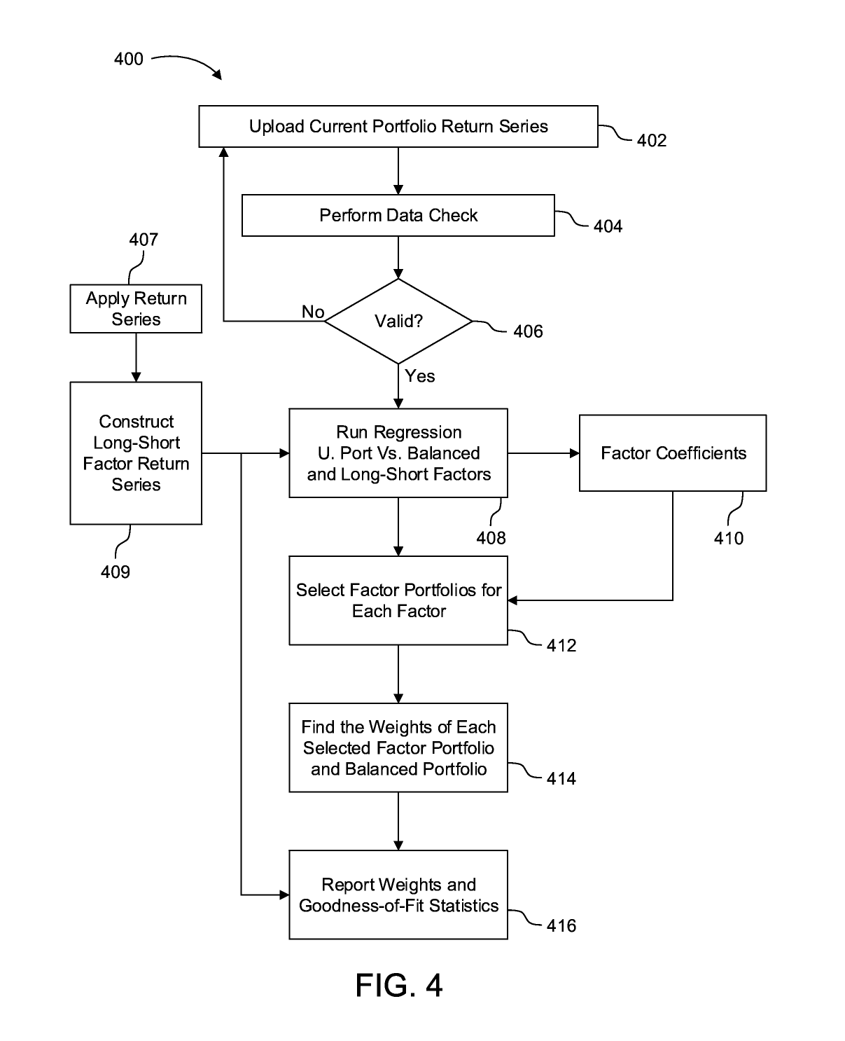

Using instructions stored in memory module 206, device 200 may read the instructions to have CPU 204 execute the functions specified in the instructions. These functions are disclosed in greater detail by FIGS. 3A, 3B and 4. Thus, computing device 200 is configured to be a special purpose device for performing a completion portfolio analysis.

FIG. 3A depicts a flowchart 30 for determining a completion portfolio according to the disclosed embodiments. The steps shown in FIG. 3A are disclosed in greater detail by FIG. 3B. A user may choose a target blend. The disclosed embodiments evaluate the current factor exposure of an existing portfolio. A returns-based factor analysis is performed.

Step 32 executes by uploading the existing portfolio. Actually, the user uploads a historical return series of an external fund, which is widely available for most funds. As noted below, any factor weights are not known for the existing portfolio. Step 34 executes by analyzing the historical return series to estimate the current allocation. Step 36 executes by determining the factor exposure for the return series. The analysis synthesizes, or replicates, the user uploaded portfolio using the factor portfolios disclosed below. The result may be displayed.

Step 38 executes by selecting a factor blend. The user may select a factor blend using a graphical user interface on device 200 that replicates the result of the factor analysis above. The factor blend may be used to set a target portfolio by applying a set of weights of the factors. Step 40 executes by determining a completion portfolio using the target portfolio and the existing portfolio. The completion portfolio may represent the actual gap or difference between the current factor allocation and a desired allocation. The completion portfolio is built to address that gap.

Using the process disclosed in FIG. 3A, the user can select the factor blend that complements current factor exposures to achieve a desired overall factor exposure result. The completion portfolio may be displayed to the user. Again, the completion portfolio is built using the target factor allocation and a current factor exposure. These concepts are disclosed in greater detail by FIGS. 3B and 4.

FIG. 3B depicts a flowchart 300 for synthesizing a current factor exposure and a completing a portfolio according to the disclosed embodiments. The disclosed embodiments construct thoughtfully designed portfolios implementing the best practices in modern portfolio construction and implementation technology. The disclosed embodiments avoid reliance on complex algorithm and machinery. The portfolios generated or considered by the disclosed embodiments are designed to be well diversified, efficient, inexpensive to implement, and capacity-aware to scale to meet the needs of even the largest institutional investors.

This specification may discuss several different types of portfolios. Four of these portfolios may be defined as follows. A factor portfolio may be the ingredient portfolio that is designed to provide efficient exposure to a particular risk factor. Factors can be considered in pairs, one pair for each risk factor representing both “sides” of its manifestation. Examples of these include Winners and Losers for the Momentum Factor, Value and Growth for the Value Factor, and so on. A factor portfolio also may be referred to as an ingredient portfolio.

A blended portfolio is a combination of factor portfolios. Blended portfolios may be as simple as a combination of two factor portfolios, such as value plus robust quality. Alternatively, blended portfolios may include more complicated blends of several factor portfolios.

A benchmark portfolio is used and displayed using the disclosed embodiments as points of comparison. The benchmark portfolio also is used as a proxy for the overall market in computing various analytics. The benchmark portfolios are typically cap-weighted portfolios and, while widely used as investment portfolios more broadly, are not intended to be used as investment portfolios in this context.

A user portfolio is uploaded by the user and is displayed using the disclosed embodiments. A user portfolio may be automatically analyzed according to the disclosed embodiments, especially those related to FIG. 3, in order to better understand factor exposures of the uploaded portfolio or to synthesize a blended factor portfolio that most closely tracks the uploaded portfolio.

The disclosed embodiments seek to complement a current user portfolio with a completion portfolio, which provides well-diversified, efficient, and inexpensive exposure to a plurality of factors. With respect to the disclosed embodiments, these factors are

Value;

Quality;

Momentum;

Low-Volatility; and

Illiquidity.

These factors are chosen because there is a significant amount of theoretical and empirical support for the idea that these factors offer a long-term risk premium that is likely to persist in the future. The risk premium is relatively inexpensive to harvest at institutional scale through portfolio construction techniques that are well tested, intuitive to understand and robust. There is sufficient historic data to evaluate its performance during various “bad times” for each factor, as well as during “bad times” for the equity markets and the economy in general.

Factor portfolios can be thought of in pairs. In other words, the disclosed embodiments construct two long-only portfolios. Each of these portfolio pairs is designed to harvest each “side” of a factor, and based on investor objectives, one “side” or the other of a particular factor or a set of factors may be desirable for a particular circumstance. For example, the disclosed embodiments construct a value portfolio and a growth portfolio. The pair of portfolios is designed to provide exposure to the “value factor.” Similarly, the disclosed embodiments construct “winner” and “loser” portfolios, and this pair of portfolios is designed to provide exposure to the momentum factor. Because the disclosed embodiments may support four (4) different factors, the embodiments may build eight (8) distinct factor portfolios. These eight factor portfolios may be combined in different proportions to form an enormously rich range of blended factor portfolios.

Because each of the 8 factor portfolios is long-only, all the portfolios contain exposure to the market factor. It is possible to build portfolios that minimize exposure to the market factor by taking short positions in one or more of the factor portfolios or in some broad market proxy, but it is important to note that each factor portfolio includes only long positions, which also improves implementability for many investors who may have reasons for desiring to utilize long-only investments.

A factor portfolio may be constructed as follows. First, the disclosed embodiments select a subset of stocks that are eligible to be held in the portfolio. This step may be disclosed in greater detail below, but the important point is that not every stock is considered for a portfolio.

Next, a weighting stage is conducted to associate a weighting methodology with the stocks that are selected for the particular factor portfolio. The choice of a weighting scheme is determined by the disclosed embodiments, and based on the best theoretical and empirical weighting of selected stocks for each factor portfolio. Preferably, a picked weighting scheme is one that will result in a portfolio that provides exposure to each risk factor in a robust, logical, and stable manner.

In other words, the factor portfolios strive to achieve the dual goals of being a good representation of each factor, as well as being a robust and well-diversified portfolio, through both stock selection and weighting. This weighting stage is disclosed in greater detail below. Once this stage is complete, the disclosed embodiments generate a well-defined set of holdings.

Referring back to FIG. 3B, step 302 executes by accessing a device, such as computing device 200, using input devices 218, for example. Using this access, a user may access system 100 to run the disclosed embodiments and the functionalities provided therein. Preferably, a graphical user interface will appear to the user to prompt the input of information to use the disclosed embodiments. Step 304 executes by uploading a user portfolio to device 200, or, alternatively, a server computing device 102 or 104. The user selects a portfolio of investments to provide information to the disclosed embodiments. For example, the portfolio may be a group of mutual funds allocating resources to several, dozens, hundreds or thousands of different financial instruments.

Step 306 executes by retrieving portfolio returns data for the uploaded portfolio. This data may be used for factor evaluation. Returns data may be limited to one year, two years, or much longer.

Step 308 executes by determining whether the uploaded portfolio data is suitable for use in the disclosed embodiments. If no, then step 310 executes by reporting a problem to the user via computing device 200. A message may appear on display 290 alerting the user that the information provided is not suitable. The user may then try to find the proper format for the uploaded portfolio.

If step 308 is yes, then step 312 executes by synthesizing the factor exposure of the uploaded portfolio. In a sense, this process is akin to “reverse engineering” the factor building process disclosed above to build a portfolio. Thus, to better understand the disclosed embodiments, the construction of a factor blended portfolio is disclosed in greater detail. Step 312 is then further disclosed by FIG. 4.

As disclosed above, the first stage in constructing a factor portfolio is to select assets, such as stocks, that are to be included in the factor portfolio. For the uploaded portfolio, however, the stocks already have been selected. Thus, in the synthesizing process, the uploaded portfolio return streams are evaluated. A factor score may be assigned to the portfolio. The portfolio then may be categorized by scores for each factor.

The disclosed embodiments associate each factor with a pair of portfolios, referred to as the “top” and “bottom” portfolios for that factor. For example, the “top” and “bottom” portfolios for the Value factor are called “Value” and “Growth.” Table 1 below disclosed the top and bottom factor portfolios for each factor:

TABLE 1

| Factor | “Top” Portfolio | “Bottom” Portfolio |
|---|---|---|
| Value | Value | Growth |
| Momentum | Momentum | Contrarian |
| Low Volatility | Stable | Aggressive |
| Quality | HighQ | LowQ |

The uploaded portfolio will be scored based on the factors to each applicable factor pair.

Table 2 discloses the factor scores used to rank each stock when building a factor portfolio:

TABLE 2

| Factor | Scoring Method |
|---|---|
| Value | Average of non-NA, winsorized z-scores of the following |
| | accounting ratios: Price-to-Book and Dividend-Yield. |
| Momentum | Returns over the trailing t-minus-12 to t-minus-1 months |
| | (scaled by observed volatility over the same period). |
| Quality | Average of non-NA, winsorized z-scores of the following |
| | accounting metrics (applied without broad sector controls): |
| | Profitability (cash earnings to book value) and Earnings |
| | Growth (ratio of trend to mean absolute level). |
| Low | Volatility of trailing 2 years of weekly returns. |
| Volatility | |

Stocks that generate NA scores are excluded from both the “top” and “bottom” portfolios for that factor. In other words, this applies if no accounting ratios are available for a particular asset, or stock. After assigning a score to each eligible asset, or stock, the disclosed embodiments order, or rank, the assets by the scores. Hereinafter, the term “stock” will be used but this term also includes any type of asset.

The top tercile of stocks are selected for the “top” portfolio associated with the factor, such as Value, and the bottom tercile of stocks are selected for the “bottom” portfolio associated with that factor, such as Growth. The tercile boundaries are treated as “soft thresholds” in the sense that they are subject to buffer conditions in order to avoid unnecessary trading in stocks that are close to the tercile boundaries.

In order to determine membership in the top or bottom tercile, the disclosed embodiments consider a buffer zone of 50% of the tercile, or 16.66%, to reduce churn and turnover. Thus, a stock that is classified in any given rebalancing data as a Value stock will remain classified as a Value stock as long as it falls within the top tercile plus the buffer zone, or the top 33.3% plus the buffer of 16.7%, which equals 50%.

Thus, a stock that is classified as a value stock because it was previously in the top tercile will continue to be classified as a Value stock as long as it remains in the top half of the Value score ranking. Similarly, a Growth stock will remain classified as a Growth stock as long as it previously was in the bottom tercile in the Value score and thereafter remains in the bottom half of the Value score. For a stock, however, to be newly considered a Value stock, it must rise to well within the interior of the top tercile of stocks when ordered by their Value scores. This buffering introduces “stickiness” in the classification and reduces turnover and transient classification in the factor analysis.

Having completed the “top” and “bottom” factor portfolio evaluation, or selection, stage, the disclosed embodiments assign weights to the assets, or stocks, within that selection, or evaluation. The choice of stock weighting scheme is done on a case-by-case basis for each factor based on the characteristics of the factor. In general, the rationale that drives the weighting decision is the implicit risk in the factor portfolio. For factor portfolios that can be expected to consist of highly risky and volatile stocks, the disclosed embodiments de-risk the portfolio by applying Minimum Volatility weighting. For baskets of stocks that represent a lower level of risk, the disclosed embodiments exploit the latent correlation benefit in the basket by de-correlating the portfolio by using Max Decorrelation.

The choices may be summarized in Table 3:

TABLE 3

| Factor | Portfolio | Name | Weighting |
|---|---|---|---|
| Value | Top | Value | Min Vol |
| | Bottom | Growth | Max Decorrelation |
| Momentum | Top | Momentum | Max Decorrelation |
| | Bottom | Contrarian | Min Vol |
| Quality | Top | HiQ | Max Decorrelation |
| | Bottom | LowQ | Min Vol |
| Low Volatility | Top | Stable | Max Decorrelation |
| | Bottom | Dynamic | Min Vol |

The disclosed embodiments ensure that the maximum position taken in any stock is related to the market cap weight of the stock. Thus, each ingredient portfolio has a limit that is calibrated to avoid extremely large weights, relative to the weight it would have been assigned in a cap weighted portfolio. The extent to which this is applied can be tuned depending on the range of market caps in the uploaded portfolio and the different choices of weighting schemes, but historically they have resulted in cumulative adjustments of less than 3% to 5% of the portfolio weights.

A brief discussion of the weighting rationale of the weighting schemes for each factor portfolio is provided. Each “top” portfolio corresponds to the portfolio that is expected to have a positive long term risk adjusted factor premium (relative to the bottom portfolio). In contrast, the “bottom” portfolio is expected to provide a lower risk adjusted return over the long term. The operating words in the preceding sentence are “over the long term.” Unfortunately, these premia can demonstrate very significant time-variation.

Specifically, there are several periods when the sign of the factor premium might be inverted, such as Value scored stocks may underperform the Growth scored stocks. These periods may persist for uncomfortably long durations. Thus, it is often desirable to maintain some exposure to the “bottom” portfolios, even though they represent lower risk adjusted returns in the long term. Another way of stating that the “bottom” portfolios can be expected to have a lower risk adjusted return than their “top” counterparts is that the “bottom” portfolios can be expected to have a higher risk relative to their expected returns in comparison to their “top” portfolio counterparts.

As a general rule, therefore, the disclosed embodiments can preserve broad diversified long-term exposure for “top” portfolios. On the other hand, for the “bottom” portfolios, the disclosed embodiments can be utilized by an investor who has a reason, either due to perception of current market conditions, or to complement other portfolios, for choosing the “bottom” portfolios. Thus, the disclosed embodiments proceed where there are a sufficient number of stocks.

In order to obtain broad diversification, or de-correlate, from the “top” portfolios, the disclosed embodiments use Max Decorrelation. Max Decorrelation aims to assign weights in order to exploit the latent correlation potential in a basket of stocks, without relying on historical volatilities. For the “bottom” portfolios, the disclosed embodiments limit the risk exposure, or de-risk, in these portfolios by employing Min Vol weighting to reduce the volatility of the “bottom” portfolio.

Referring to FIG. 4, the synthesizing process of step 312 is disclosed in greater detail by flowchart 400. Step 402 executes by uploading the current portfolio return series retrieved in step 306. Step 404 executes by performing a data check. Step 406 determines whether the data is valid. If no, then flowchart 400 returns back to step 402 to allow for correction of the uploaded data.

If step 406 is yes, then step 408 executes by running regression analysis of the uploaded portfolio versus balanced and long-short factors. Steps 410 and 412 flow into step 408. Step 407 executes by applying a return series. This step uses the concepts disclosed above to return a balanced portfolio constructed using the factors and stages. This step also returns top and bottom factor portfolios. Step 409 executes by constructing long and short factor return series. These returned portfolios may be used in the regression analysis used in step 408.

Step 410 executes by determining factor coefficients for each asset within the uploaded portfolio. Factor coefficients may range from −1 to 1. Step 412 executes by selecting factor portfolios (top or bottom) for each factor using the signs of the coefficients from the regression.

Step 414 executes by finding the weights of each selected factor portfolio and balanced portfolio by minimizing the tracking error of the synthesized portfolio relative to the uploaded portfolio. Step 414 may use a Sharpe's return-based style analysis. The weight may be shown as w=min Var (uploaded portfolio−sum of weights). Step 416 executes by reporting the weights of each selected factor portfolio.

Returning back to FIG. 3B, step 314 executes by determining the user's current factor allocation based on the weights for each selected factor portfolio. A discussion of weights on the different factor portfolios is given above.

Step 318 executes by calculating a completion portfolio factor allocation. This step may compare the uploaded portfolio factor exposure to a target factor exposure inputted in step 316. The user may input a target factor portfolio using the graphical user interface supported by computing device 200. This is shown in greater detail below. Step 318 results in determination of a completion portfolio to achieve the target factor exposure. Completion portfolio factor exposure may be shown by the weights returned by flowchart 400.

Step 320 executes by calculating analytics for completion, target and current uploaded portfolio. These analytics are presented to the user on display 290. Step 322 executes by determining whether the user is satisfied with the completion factor portfolio to achieve the target portfolio. If no, then flowchart 300 goes to step 316 to have the user input another target factor exposure. If step 322 is yes, then step 324 executes by investing resources into the completion portfolio.

The disclosed embodiments, therefore, upload an existing portfolio and provide a synthesize process to determine how the existing portfolio fares against the factors disclosed above. The existing portfolio is scored and ranked, and respective factor results are provided. The user then inputs a target factor portfolio using the factors disclosed above. The existing portfolio is then compared against the target portfolio. The result is a completion portfolio to complement the existing portfolio and derive a total factor exposure in line with investor objectives.

It will be apparent to those skilled in the art that various modifications and variations can be made in the disclosed embodiments of the disclosed device and associated methods without departing from the spirit or scope of the invention. Thus, it is intended that the present invention covers the modifications and variations of the embodiments disclosed above provided that the modifications and variations come within the scope of any claims and their equivalents.

What is claimed is:

1. A method for building a completion portfolio for an existing portfolio, the method of comprising:
estimating a factor allocation for the existing portfolio, wherein the factor allocation includes a set of factors;
determining a target factor portfolio based on a selected factor blend of the set of factors;
comparing the target portfolio to the factor allocation of the existing portfolio to determine a difference between the factor allocation and the selected factor blend; and
building a completion portfolio according the difference.

2. The method of claim 1, wherein the estimating step includes analyzing a historical return series of the existing portfolio.

3. The method of claim 2, further comprising scoring the existing portfolio based on the set of factors.

4. The method of claim 1, further comprising inputting the target factor portfolio using a graphical user interface on a device.

5. The method of claim 4, wherein the graphical user interface displays graphical representation of the set of factors.

6. The method of claim 1, further comprising calculating analytics on the completion portfolio.

7. The method of claim 1, further comprising uploading the existing portfolio to a server.

8. The method of claim 7, further comprising retrieving existing portfolio return data to the server.

9. The method of claim 1, wherein the estimating step includes running a regression on the existing portfolio versus the set of factors.

10. The method of claim 9, wherein the set of factors includes balanced and long-short factors.

11. A method for building a completion portfolio, the method comprising:
uploading an existing portfolio;
analyzing a return series for the existing portfolio to estimate an allocation of factor blends within the existing portfolio;
selecting a target factor blend for a target portfolio;
comparing the target factor blend to the estimated allocation of factor blends; and
determining a completion portfolio based on the comparison.

12. The method of claim 11, wherein the selecting step includes selecting factor portfolios for each factor.

13. The method of claim 11, wherein the analyzing step includes running a regression analysis on the return series.

14. The method of claim 11, further comprising inputting the target factor blend.

15. The method of claim 11, further comprising investing in the completion portfolio.

16. A physical and tangible computer readable medium for storing non-transitory computer readable instructions, the computer readable instructions performing a method for building a completion portfolio for an existing portfolio when executed by one or more processing devices, the method comprising:
estimating a factor allocation for the existing portfolio, wherein the factor allocation includes a set of factors;
determining a target factor portfolio based on a selected factor blend of the set of factors;
comparing the target portfolio to the factor allocation of the existing portfolio to determine a difference between the factor allocation and the selected factor blend; and
building a completion portfolio according the difference.

17. The computer readable medium of claim 16, wherein the estimating step includes analyzing a historical return series of the existing portfolio.

18. The computer readable medium of claim 16, wherein the method further includes inputting the target factor portfolio using a graphical user interface on a device.

19. The computer readable medium of claim 16, wherein the estimating step includes running a regression on the existing portfolio versus the set of factors.

20. The computer readable medium of claim 16, wherein the method further includes investing in the completion portfolio.
